(19) United States
(12) Patent Application Publication
(10) Pub. No.: US 2026/0359600 A1
(43) Pub. Date: Nov. 12, 2026

(54) METHOD FOR IMPROVING RESOURCE UTILIZATION IN DEEP LEARNING ACCELERATOR DATA PROCESSING

(71) Applicant: MEDIATEK INC., Hsinchu City (TW)

(72) Inventors: Hsien-Peng Wang, Hsinchu City (TW); Wei-Ting Hung, Hsinchu City (TW); Chieh-Fang Teng, Hsinchu City (TW); Yi-Yen Hsieh, Hsinchu City (TW)

(73) Assignee: MEDIATEK INC., Hsinchu City (TW)

(21) Appl. No.: 19/203,162

(22) Filed: May 8, 2025

(51) Int. Cl. G06N 3/044; G06N 3/0464

(52) U.S. Cl. CPC G06N 3/044; G06N 3/0464

(57) ABSTRACT

A method for processing data may comprise processing, by a first device, first tile data to generate second tile data during a first time period; processing, by a second device, the second tile data to generate third tile data during a second time period; and processing, by the first device, fourth tile data to generate fifth tile data during the second time period. The first tile data, the second tile data, and the third tile data correspond to data processed by a first thread, and the fourth tile data and the fifth tile data correspond to data processed by a second thread.

### BACKGROUND

In modern machine learning architectures, neural network operations frequently encounter resource utilization inefficiencies. Although these architectures can employ multiple execution units for processing large volumes of data, the units often experience waiting periods between operations, resulting in reduced utilization rates.

Specifically, execution units must frequently await the completion of operations by another execution unit before proceeding with its operation due to data dependency. This unintended idle execution resource, arising from long waiting periods, is known as “dark silicon”, which manifests as a substantial disparity between invested resources and actual resource utilization. Such inefficient resource allocation significantly impairs overall system performance. The presence of these idle periods represents a critical challenge in optimizing the operational efficiency of machine learning architectures.

### SUMMARY

An embodiment provides a method for processing data. The method includes processing, by a first device, first tile data to generate second tile data during a first time period; processing, by a second device, the second tile data to generate third tile data during a second time period; and processing, by the first device, fourth tile data to generate fifth tile data during the second time period. The first tile data, the second tile data, and the third tile data correspond to data processed by a first thread, and the fourth tile data and the fifth tile data correspond to data processed by a second thread.

Another embodiment provides a method of processing data. The method includes processing, by a first device, first tile data to generate second tile data during a time period; and processing, by a second device, third tile data to generate fourth tile data during the time period. The first tile data and the second tile data correspond to data processed by a first thread, the third tile data and the fourth tile data correspond to data processed by a second thread, first data includes the first tile data and the third tile data, second data include the second tile data and the fourth tile data, and the first data is different from the second data.

Another embodiment provides a system for processing data. The system includes a first device, a second device and a memory. The first device is used to perform a first data-processing operation. The second device is used to perform a second data-processing operation. The memory is linked to the first device and the second device. During a first time period, the first device performs the first data-processing operation to process first tile data to generate second tile data. During a second time period, the second device performs the second data-processing operation to process the second tile data to generate third tile data. During the second time period, the first device performs the first data-processing operation to process fourth tile data to generate fifth tile data. The first tile data, the second tile data and the third tile data correspond to a first thread, and the fourth tile data and the fifth tile data correspond to a second thread. The memory is used to store at least one of the first tile data, the second tile data, the third tile data, the fourth tile data, and the fifth tile data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a data processing diagram according to an embodiment.

FIG. 2 illustrates a system for processing data according to an embodiment.

FIGS. 3-7 illustrate sequential data processing operations according to an embodiment.

FIG. 8 illustrates a data processing diagram according to another embodiment.

FIG. 9 illustrates a data processing diagram according to another embodiment.

FIG. 10 illustrates a flowchart of a data processing method according to an embodiment.

FIG. 11 illustrates a flowchart of a data processing method according to another embodiment.

### DETAILED DESCRIPTION

According to embodiments, neural network models can include multiple layers, with each layer executing specific operations such as convolution. These operations can exhibit data dependencies, where subsequent operations may require outputs from preceding operations. A deep learning accelerator (DLA) architecture can incorporate multiple execution units to process substantial amounts of data. However, memory constraints may prevent the entire input data from fitting into local buffers, necessitating data tiling strategies where input data is segmented into smaller tiles for processing across layer operations. The aforementioned tiles represent data of reduced dimensions. In this context, larger data structures can be partitioned into multiple pieces of tile data. The accelerator can process these multiple pieces of tile data separately to reduce memory access requirements and achieve improved hardware utilization efficiency. The processing and combination of multiple pieces of tile data can constitute a flow of data fusion. This architectural design introduces operational inefficiencies as execution units often remain idle while waiting for dependent tile operations to complete. When an engine (e.g., hardware execution unit) processes a specific tile, other engines designed for different operations may enter an idle state until their dependent data becomes available. The execution units may alternate between processing tiles and remaining idle, creating periods of inactivity that impact overall system efficiency. This challenge necessitates architectural solutions to maintain continuous utilization of execution units during these otherwise idle periods.

FIG. 1 illustrates a data processing diagram according to an embodiment. This figure serves as an exemplary illustration and the scope of embodiments is not limited thereto. In FIG. 1, data D1 can be processed through a layer L1 to generate data D2. The data D2 can be processed through a layer L2 to generate data D3. Subsequently, the data D3 can be processed through a layer L3 to generate data D4. Each of the layer L1, layer L2, and layer L3 can correspond to a predetermined operation, representing a processing stage that transforms input data in a specific way.

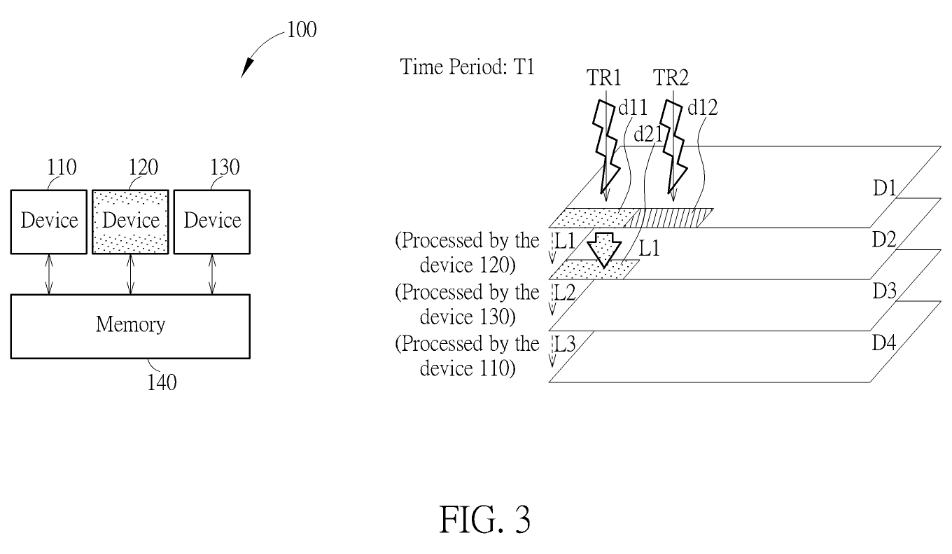

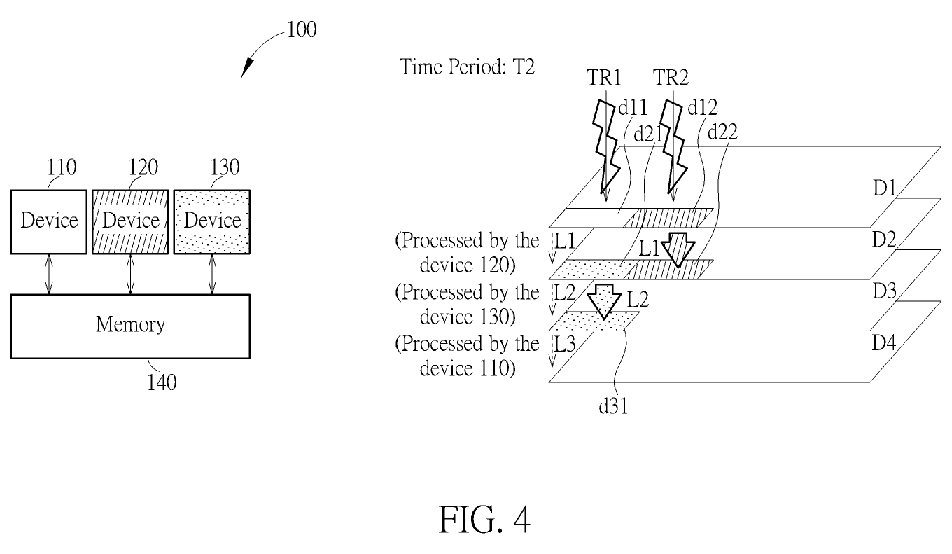

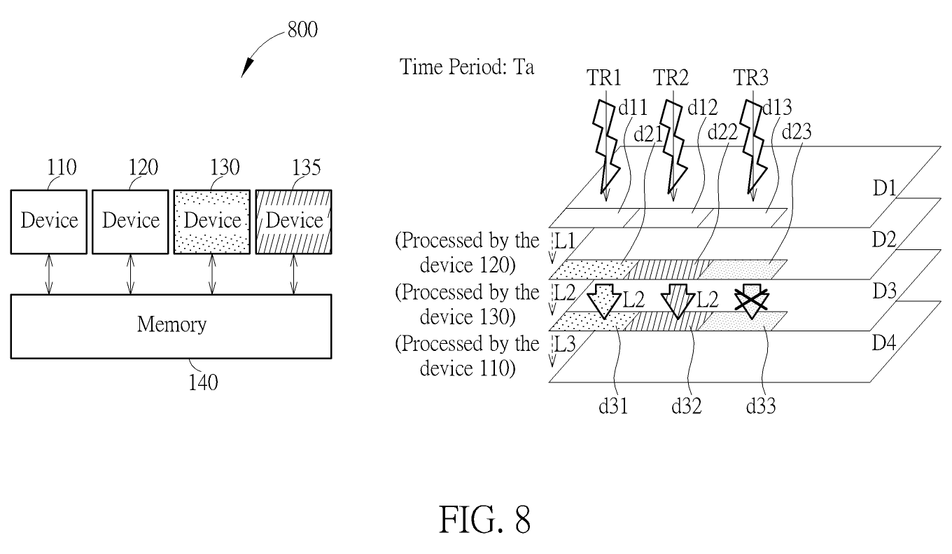

In FIGS. 1 and 3-9, the layers L1, L2, L3 represented by dashed arrows illustrate that the data D1 may be processed through the layer L1 to generate the data D2, the data D2 may be processed through the layer L2 to generate the data D3, and the data D3 may be processed through the layer L3 to generate the data D4. However, the layers L1, L2, L3 represented by dashed arrows do not indicate that corresponding operations have been performed. For example, as shown in FIG. 3, when the layer L1 is represented by a larger arrow, it indicates that the operation corresponding to the layer L1 is performed. Similarly, as shown in FIG. 4, when the layers L1 and L2 are represented by larger arrows, it indicates that operations corresponding to the layers L1 and L2 are performed, and so forth. In FIG. 8, when a larger arrow is marked with a cross, it indicates that the corresponding operation is not allowed to be performed.

For example, the layer L1 can be implemented as a convolutional layer, which can function to detect edges and corners of patterns, identify shapes and textures of patterns, and/or detect more complex features such as faces or objects. The layer L2 can be implemented as a pooling layer, which can serve to adjust the size of the data while preserving important information. For example, max pooling can capture strong signals from each small region. In a specific implementation, when processing a 4x4 image using 2x2 max pooling, it may generate a 2x2 output containing the highest values from each section. The layer L3 can be implemented as a Softmax layer, typically serving as a final layer for classification tasks. To illustrate with a simple example, the layer L3 can convert the network's raw outputs into probabilities that sum to 1. For instance, in the context of animal image classification, the Softmax layer may output probabilities such as Dog: 0.7 (70% confident), Cat: 0.2 (20% confident), and Bird: 0.1 (10% confident), thereby assisting users in making determinations. The aforementioned examples are merely illustrative, as each of the layer L1, layer L2, and layer L3 can be implemented as other types of layers in AI processing.

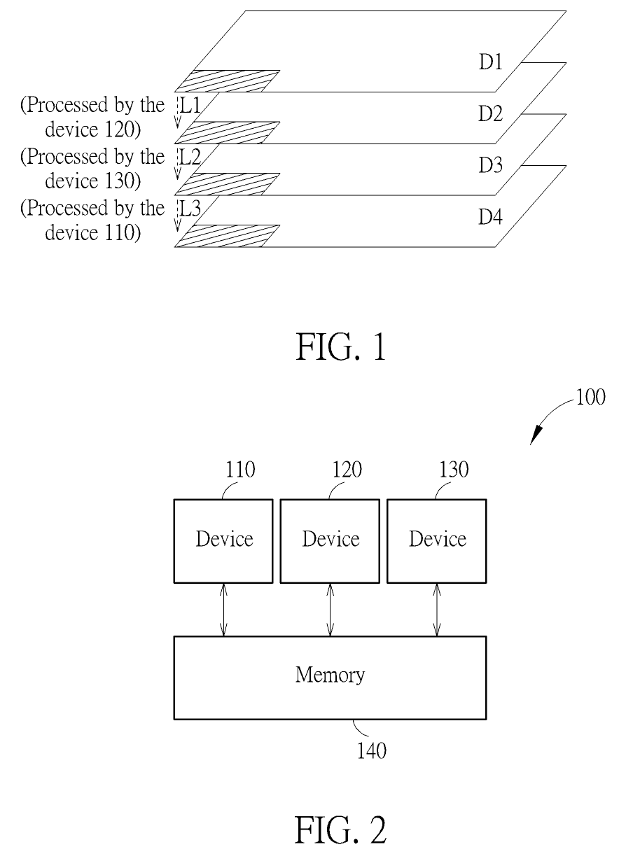

FIG. 2 shows a system 100 for processing data according to an embodiment. The system 100 can include a device 110, a device 120, a device 130, and a memory 140. Each of the device 110, the device 120, and the device 130 may be implemented as a hardware engine, such as a hardware accelerator. Each of the device 110, the device 120, and the device 130 may be a hardware execution unit, which can be a portion of a processing unit, and used to execute corresponding operations and computations associated with a layer. The aforementioned processing unit may be implemented as a neural processing unit (NPU) or another suitable processing unit. For example, as illustrated in FIGS. 1 and 2, operations of the layer L1 can be executed by the device 120, operations of the layer L2 can be executed by the device 130, and operations of the layer L3 can be executed by the device 110. The memory 140 can be utilized to store data processed by the device 110, the device 120, and the device 130. For example, the memory 140 can store the data D1 through the data D4, as well as their associated tile data described below.

The device 110 can perform the data-processing operation for the computation of the layer L3. The device 120 can perform the data-processing operation for the computation of the layer L1. The device 130 can perform the data-processing operation for the computation of the layer L2. These implementations are provided as examples, and embodiments are not limited thereto.

The memory 140 can include Static Random-Access Memory (SRAM), Dynamic Random-Access Memory (DRAM), cache memory, buffer memory, or any combination thereof, and can be linked to the devices 110 to 130 for data access during computations.

As illustrated in FIGS. 1 and 2, since each of the data D1, data D2, and data D3 may have large dimensions that create processing challenges, data of large dimensions can be divided into multiple pieces of tile data of smaller dimensions for processing.

Below, each of FIGS. 3-9 illustrates the data being processed and the corresponding system utilization states. In the drawings of the present disclosure, when a block corresponding to a device is shaded, it indicates that the device is in use and busy. When a block corresponding to a device is unshaded, it indicates that the device is not in use and the corresponding resource is available.

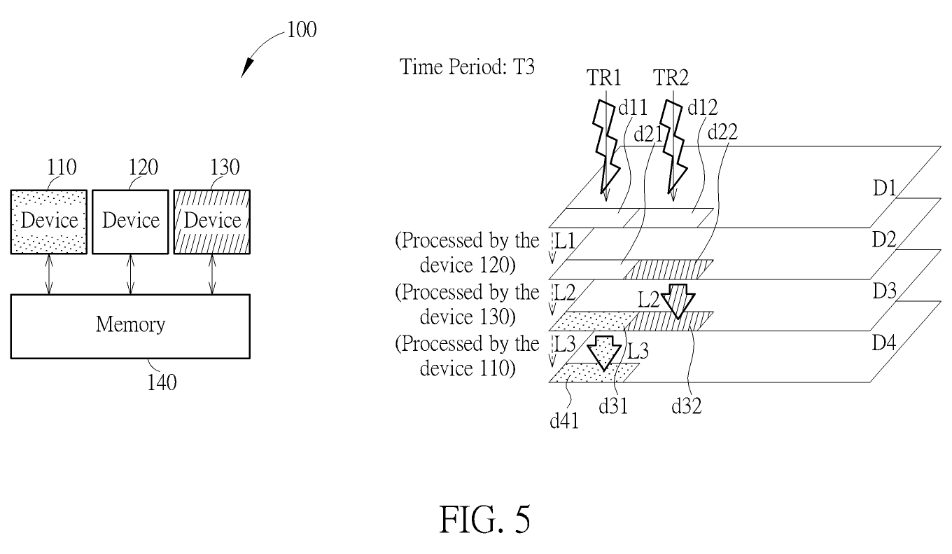

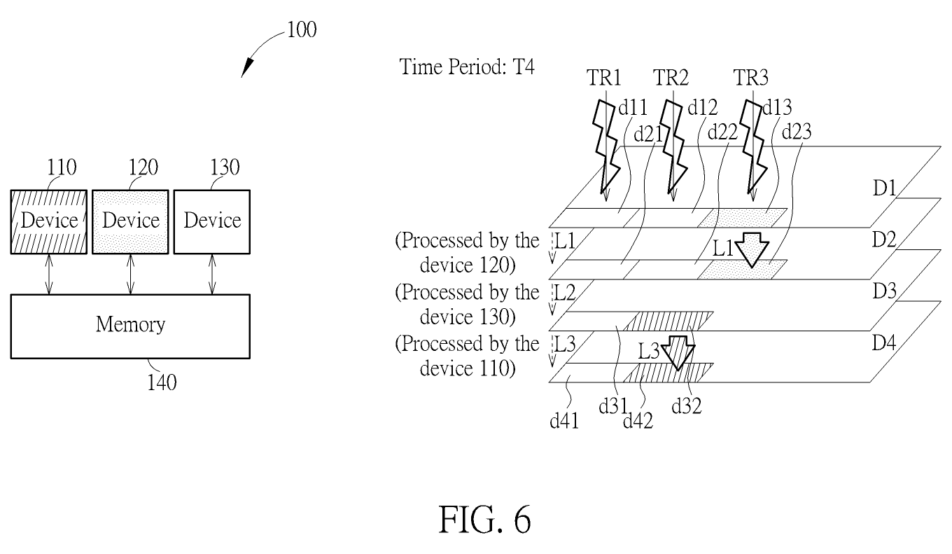

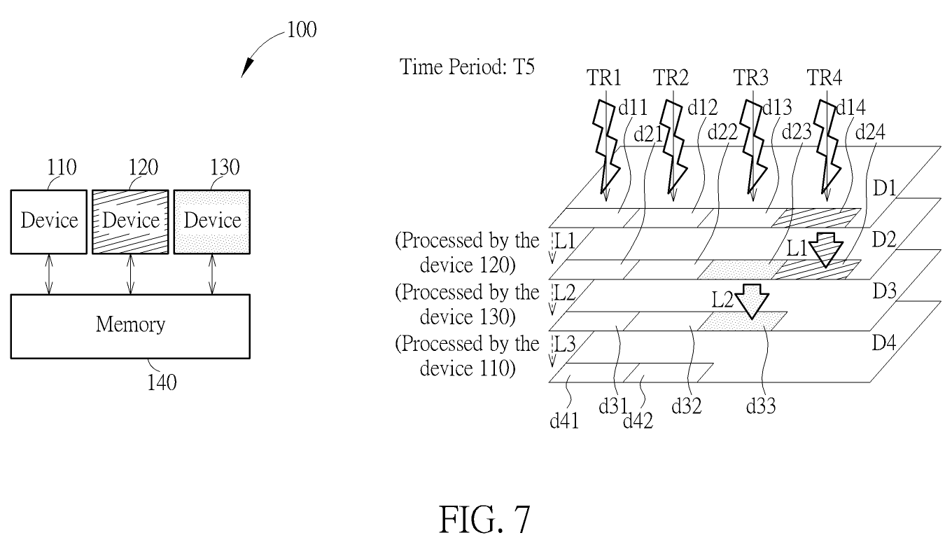

FIGS. 3-7 illustrate sequential data processing operations according to an embodiment. These operations can be executed in a chronological sequence, where the procedure illustrated in FIG. 3 can be executed first, followed by the procedure illustrated in FIG. 4, which is subsequently followed by the procedure illustrated in FIG. 5. This sequential progression can continue such that upon completion of the procedure illustrated in FIG. 6, the procedure illustrated in FIG. 7 is executed. Each of FIGS. 3-7 illustrates the device(s) utilized during the depicted processing operations.

FIG. 3 corresponds to a first time period T1. In FIG. 3, the data D1 can include tile data d11 and tile data d12. The tile data d11 can be processed through the layer L1 using the device 120 to generate tile data d21. In FIG. 3, the tile data d12 cannot be processed because the device 120 is processing tile data d11. In FIG. 3, the data processing related to tile data d11 corresponds to a thread TR1. The data processing related to tile data d12 corresponds to a thread TR2, where the thread T2 is different from the thread TR1.

FIG. 4 corresponds to a second time period T2. As shown in FIG. 4, the data D2 can include the tile data d21 and tile data d22. The tile data d12 can be processed through the layer L1 using the device 120 to generate tile data d22. As shown in FIG. 4, the data D3 includes tile data d31. The tile data d21 can be processed through the layer L2 using the device 130 to generate tile data d31. As shown in FIG. 4, during the second time period T2, the thread TR1 can be processed in parallel to generate the tile data d31 while the thread TR2 is processed to generate the tile data d22.

FIG. 5 can correspond to a third time period T3. As shown in FIG. 5, the data D3 includes the tile data d31 and tile data d32. The tile data d31 can be processed through the layer L3 using the device 110 to generate tile data d41 of the data D4. The tile data d22 can be processed through the layer L3 using the device 130 to generate the tile data d32. As shown in FIG. 5, during the third time period T3, the thread TR1 can be processed in parallel to generate the tile data d41 while the thread TR2 is processed to generate the tile data d32. As shown in FIG. 5, after the tile data d41 of the fourth data D4 is generated, operations of the thread TR1 are completed.

FIG. 6 can correspond to a fourth time period T4. As shown in FIG. 6, the tile data d32 can be processed through the layer L3 using the device 110 to generate tile data d42 of the data D4. After the tile data d42 is generated, operations of the thread TR2 is completed. Therefore, a new thread TR3 can be processed. During the fourth time period T4, tile data d13 of the data D1 can be processed through the layer L1 using the device 120 to generate tile data d23 of the data D2. As shown in FIG. 6, during the fourth time period T4, the thread TR2 can be processed in parallel to generate the tile data d42 while the thread TR3 is processed to generate the tile data d23.

FIG. 7 can correspond to a fifth time period T5. As shown in FIG. 7, the tile data d23 of the data D2 can be processed through the layer L2 using the device 130 to generate tile data d33 of the data D3. During the fifth time period T5, tile data d14 of the data D1 can be processed through the layer L1 using the device 120 to generate tile data d24 of the data D2. As shown in FIG. 7, during the fifth time period T5, the thread TR3 can be processed in parallel to generate the tile data d33 while another thread TR4 is processed to generate the tile data d24.

FIGS. 3-7 illustrate parallel processing of multiple threads in a pipeline style according to an embodiment. Since multiple threads can be processed in parallel, this approach prevents other devices from remaining idle while one of multiple devices (e.g., devices 110 to 130) is in use. Therefore, hardware utilization of the processing unit (e.g., Neural Processing Unit (NPU)) can be optimized and improved. This approach enables tile threads to fully utilize execution resources in a Deep Learning Accelerator (DLA) design.

FIG. 8 shows data processing operations according to another embodiment. Similar to the above embodiment, FIG. 8 illustrates data D1 through D4. The data D1 can be processed to generate the data D2, the data D2 can be processed to generate the data D3, and the data D3 can be processed to generate the data D4. Since each of the data D1 through the data D4 has large dimensions, the data can be divided into tile data of smaller dimensions for processing through multiple threads.

As shown in FIG. 8, a system 800 can be used to process the data D1 to D4. The system 800 can include devices 110, 120, 130 and 135, and a memory 140. The devices 110, 120, 130 and 135 can be utilized for data processing operations. The device 120 can be utilized for data processing of the layer L1. The device 110 can be utilized for data processing of the layer L3. The devices 130 and 135 can be utilized for data processing of the layer L2. Similar to FIGS. 3-7, each of the devices 110, 120, 130, and 135 can include a hardware accelerator within a processing unit (e.g., Neural Processing Unit (NPU)).

As shown in FIG. 8, during the time period Ta, for the thread TR1, the tile data d21 can be processed through the layer L2 using the device 130 to generate the tile data d31. During the time period Ta, for the thread TR2, the tile data d22 can be processed through the layer L2 using the device 135 to generate the tile data d32. Unlike FIGS. 3-7, in FIG. 8, since both of the devices 130 and 135 are used for the layer L2, simultaneous processing of the two threads (TR1 and TR2) for the layer L2 is permitted. However, as shown in FIG. 8, the tile data d23 of the data D2 cannot be processed during the time period Ta due to insufficient resources, as there is no third device available for the layer L2.

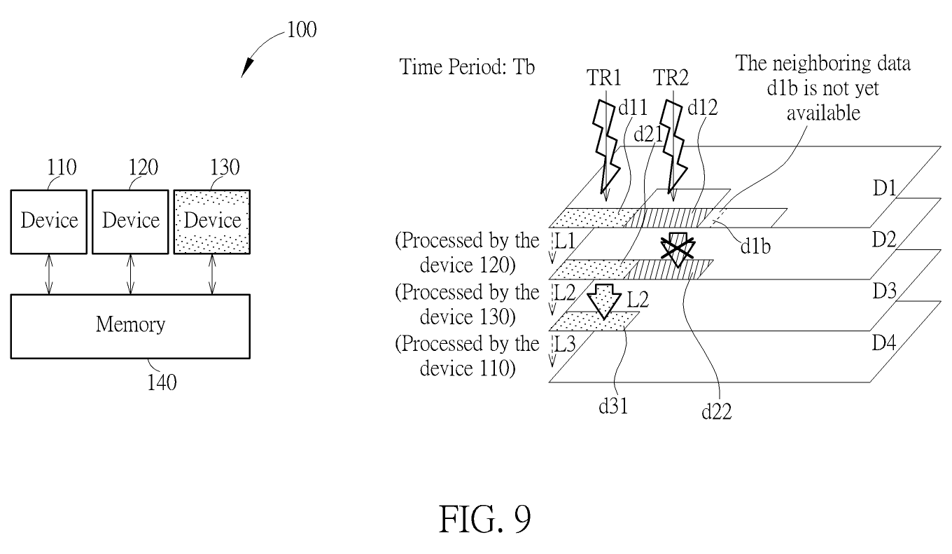

FIG. 9 illustrates data processing operations according to an embodiment. FIG. 9 can be similar to FIGS. 3-7, with similarities not repeated here. However, FIG. 9 describes a scenario where multiple threads cannot be processed in parallel.

During the time period Tb, the tile data d21 of the data D2, which corresponds to the thread TR1, can be processed through the layer L2 using the device 130 to generate the tile data d31 of the data D3. Although the devices 110 and 120 are available during this period, the processing of the tile data d12 of the data D1 through the layer L2 to generate the tile data d22 of the data D2 for the thread TR2 is prohibited. This restriction is due to the unavailability of neighboring data (denoted as d1b) of the tile data d12 in the data D1 during the time period Tb.

Due to “data dependency” between the tile data d12 and the neighboring data d1b, the processing of the tile data d12 to generate the tile data d22 has to wait until the neighboring data d1b becomes available. According to embodiments, a thread cannot be executed when data dependency has not been resolved. According to embodiments, a thread may not surpass a prior thread due to data dependency. For instance, the thread TR2 is not permitted to execute operations at the layer L3 before the thread TR1 completes its operations at the layer L3. For example, in a case of 3x3 convolution, tile data may depend on neighboring cell data.

In the present disclosure, data input to a layer can be input cell data, and data output after processing can be output cell data, where dimensions of the input cell data and the output cell data can be either identical or different.

According to embodiments, when processing a tile data to generate another tile data through a layer (e.g., one of a convolution layer, a pooling layer, a fully connected layer, and other machine learning-related layers) using a hardware device, these two data elements can either have identical dimensions or different dimensions, both of which fall within the scope of embodiments. For example, as illustrated in FIGS. 3-9, the tile data d11 and the tile data d21 can possess either identical dimensions or different dimensions. In FIGS. 3-9, dimensions of multiple pieces of tile data can be either identical or different.

In the present disclosure, each of the referenced layers (e.g., the layers L1, L2, L3) can include one of the following machine learning-related layers, including but not limited to: activation layers such as ReLU (Rectified Linear Unit) Layer, Sigmoid Layer, Tanh Layer, LeakyReLU Layer, and PReLU (Parametric ReLU) Layer; normalization layers such as Batch Normalization Layer, Layer Normalization Layer, Instance Normalization Layer, and Group Normalization Layer; recurrent layers including LSTM (Long Short-Term Memory) Layer, GRU (Gated Recurrent Unit) Layer, Simple RNN Layer, and Bidirectional RNN Layer; attention layers comprising Self-Attention Layer, Multi-Head Attention Layer, and Cross-Attention Layer; special-purpose layers including Dropout Layer for regularization, Softmax Layer for classification outputs, Embedding Layer for text or categorical data processing, Upsampling/Deconvolution Layer, Skip Connection/Residual Layer, Addition/Concatenation Layer, and Average/Maximum Pooling Layer; and transformation layers such as Reshape Layer, Flatten Layer, Transpose Layer, and Padding Layer. Each layer can be utilized to perform a corresponding data-processing operation. The aforementioned layers are provided as examples only, and other suitable layers fall within the scope of the present embodiments.

Each of the aforementioned devices 110, 120, 130, and 135 can include one of a Convolution Engine, a Pooling Engine, a Matrix Multiplication Engine, a Vector Processing Engine, an Activation Engine, a Direct Memory Access (DMA) Engine, a Tensor Processing Engine, a Multiply-Accumulate (MAC) Engine, a Load-Store Engine, a Memory Access Engine, a Fast Fourier Transform (FFT) Engine, a Quantization Engine, a Sparse Matrix Engine, a Graph Processing Engine, a Recurrent Neural Network (RNN) Engine, a Normalization Engine, an Attention Mechanism Engine, a Dot-Product Engine, a Data Formatting Engine, a Compression/Decompression Engine, a Pruning Engine, a Winograd Transform Engine, a Bitwise Operation Engine, a Reduction Engine, and/or a suitable hardware engine. The engines mentioned above are provided merely as examples, and embodiments are not limited thereto, as other suitable and reasonable engines may also be employed.

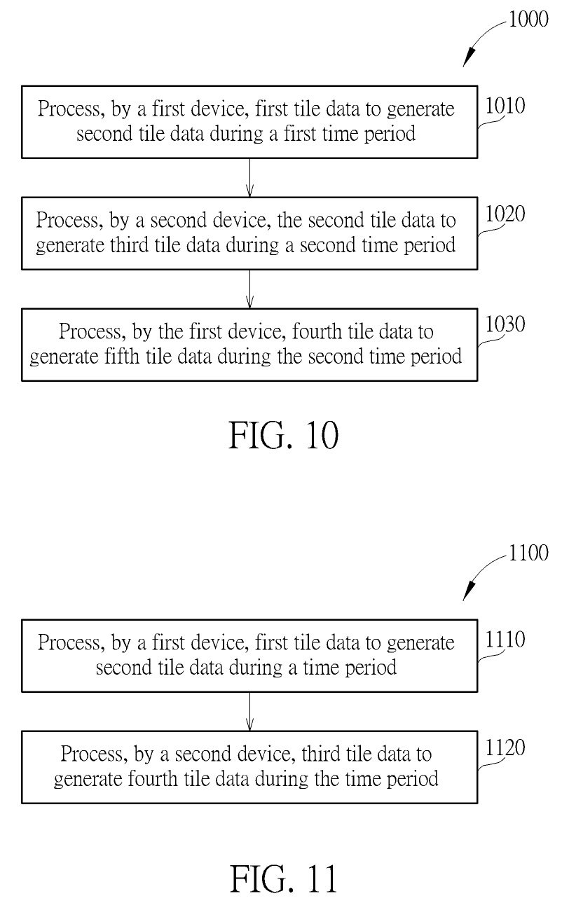

FIG. 10 illustrates a flowchart of a data processing method 1000 according to an embodiment. The method 1000 can include the following steps.
Step 1010: process, by a first device, first tile data to generate second tile data during a first time period;
Step 1020: process, by a second device, the second tile data to generate third tile data during a second time period; and
Step 1030: process, by the first device, fourth tile data to generate fifth tile data during the second time period.

For example, Step 1010 can correspond to FIG. 3, where the first device can be the device 120, the first tile data can be the tile data d11, and the second tile data can be the tile data d21. Steps 1020 and 1030 can correspond to FIG. 4, where the third tile data can be the tile data d31, the fourth tile data can be the tile data d12, and the fifth tile data can be the tile data d22.

In FIG. 10, the first tile data, the second tile data, and the third tile data can correspond to data processed by a first thread (e.g. TR1 in FIG. 3). The fourth tile data and the fifth tile data correspond to data processed by a second thread (e.g. TR2 in FIG. 3).

Regarding the process flow illustrated in FIG. 11, the method can optionally include detecting whether data dependency on neighboring data of the fourth tile data is resolved, and processing the fourth tile data to generate the fifth tile data only after the neighboring data becomes available. For example, as shown in FIG. 9, when neighboring data (e.g., the abovementioned data d1b) is not available, parallel processing of tile data of two threads TR1 and TR2 is not permitted.

Regarding the process flow illustrated in FIG. 10, the method can optionally include the following steps: (i) process, by a third device, the third tile data to generate sixth tile data during a third time period; and (ii) process, by the second device, the fifth tile data to generate seventh tile data during the third time period. For example, as shown in FIG. 5, the third tile data can be the tile data d31 of the data D3, the sixth data can be the tile data d41 of the data D4, the fifth tile data can be the tile data d22 of the data D2, and the seventh tile data can be the tile data d32 of the data D3.

FIG. 11 illustrates a data processing method 1100 according to an embodiment. The method 1100 can include the following steps.
Step 1110: process, by a first device, first tile data to generate second tile data during a time period; and
Step 1120: process, by a second device, third tile data to generate fourth tile data during the time period.

Regarding Step 1110 of FIG. 11, as illustrated in FIG. 8, the first device can be implemented as the device 130, where the first tile data can be the tile data d21, and the second tile data can be the tile data d31. For Step 1120, the second device can be implemented as the device 135, where the third tile data can be the tile data d22, and the fourth tile data can be the tile data d32. In the process flow of FIG. 11, when no data dependency exists between two pieces of tile data, tile data from two threads can be processed in parallel, provided sufficient resources are available.

According to an embodiment, to manage multiple tile threads and maintain engine efficiency, the disclosed architecture can maintain multiple instruction pointers (IPs) to track the execution of tile threads. The command unit can dispatch the decoded information per thread to the execution engines, which need to maintain threaded (multiple) command buffers.

To enable multiple threads, the command unit can spawn each available thread to memory (e.g., the memory 140) and its corresponding execution engines for processing one tile of the input data. Multiple tiles can run concurrently with the spawning of multiple threads.

Data dependency across tiles can be maintained. This means that when data dependency exists, the thread from the next iteration cannot surpass the execution of the prior thread.

The local memory unit (e.g., the memory 140) can be responsible for choosing a thread from among the contenders to use the idle engine. The local memory unit can then send the input data for the chosen thread to the execution unit. The data can include thread identification information, enabling the execution unit to determine which thread's command information to use for execution.

In summary, the methods and systems disclosed in the present embodiments optimize resource utilization in Deep Learning Accelerator (DLA) architectures. The disclosed techniques effectively address the dark silicon phenomenon by enabling efficient processing of multiple threads while maintaining proper data dependency management. The implementation provides comprehensive solutions for maximizing execution resource utilization in DLA designs through sophisticated thread management and dependency resolution mechanisms. This architectural approach significantly enhances hardware resource efficiency while ensuring data processing integrity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for processing data, comprising:
processing, by a first device, first tile data to generate second tile data during a first time period;
processing, by a second device, the second tile data to generate third tile data during a second time period; and
processing, by the first device, fourth tile data to generate fifth tile data during the second time period;
wherein the first tile data, the second tile data, and the third tile data correspond to data processed by a first thread, and the fourth tile data and the fifth tile data correspond to data processed by a second thread.

2. The method of claim 1, wherein first data comprises the first tile data and the fourth tile, second data comprise the second tile data and the fifth tile data, and the second data is different from the first data.

3. The method of claim 1, wherein the second data is generated based on the first data.

4. The method of claim 1, further comprising:
detecting whether neighboring data of the fourth tile data is available; and
processing the fourth tile data to generate the fifth tile data only after the neighboring data is available.

5. The method of claim 1, further comprising:
processing, by a third device, the third tile data to generate sixth tile data during a third time period; and
processing, by the second device, the fifth tile data to generate seventh tile data during the third time period.

6. The method of claim 5, wherein:
first data comprises the first tile data and the fourth tile data;
second data comprises the second tile data and the fifth tile data;
third data comprises the third tile data and the seventh tile data;
fourth data comprises the sixth tile data; and
the first data, the second data, the third data, and the fourth data are different from each other.

7. The method of claim 1, wherein dimensions of the first tile data are equal to dimensions of the second tile data.

8. The method of claim 1, wherein dimensions of the first tile data are different from dimensions of the second tile data.

9. A method of processing data, comprising:
processing, by a first device, first tile data to generate second tile data during a time period; and
processing, by a second device, third tile data to generate fourth tile data during the time period;
wherein the first tile data and the second tile data correspond to data processed by a first thread, the third tile data and the fourth tile data correspond to data processed by a second thread, first data comprises the first tile data and the third tile data, second data comprise the second tile data and the fourth tile data, and the first data is different from the second data.

10. A system for processing data, comprising:
a first device configured to perform a first data-processing operation;
a second device configured to perform a second data-processing operation; and
a memory linked to the first device, and the second device;
wherein during a first time period, the first device performs the first data-processing operation to process first tile data to generate second tile data;
during a second time period, the second device performs the second data-processing operation to process the second tile data to generate third tile data;
during the second time period, the first device performs the first data-processing operation to process fourth tile data to generate fifth tile data;
the first tile data, the second tile data and the third tile data correspond to a first thread, and the fourth tile data and the fifth tile data correspond to a second thread; and
the memory is configured to store at least one of the first tile data, the second tile data, the third tile data, the fourth tile data, and the fifth tile data.

11. The system of claim 10, wherein at least one of the first device and the second device comprises one of a Convolution Engine, a Pooling Engine, a Matrix Multiplication Engine, a Vector Processing Engine, an Activation Engine, a Direct Memory Access (DMA) Engine, a Tensor Processing Engine, a Multiply-Accumulate (MAC) Engine, a Load-Store Engine, a Memory Access Engine, a Fast Fourier Transform (FFT) Engine, a Quantization Engine, a Sparse Matrix Engine, a Graph Processing Engine, a Recurrent Neural Network (RNN) Engine, a Normalization Engine, an Attention Mechanism Engine, a Dot-Product Engine, a Data Formatting Engine, a Compression/Decompression Engine, a Pruning Engine, a Winograd Transform Engine, a Bitwise Operation Engine, a Reduction Engine, and a suitable hardware engine.

12. The system of claim 10, wherein at least one of the first device and the second device is installed in a Neural Processing Unit (NPU).

13. The system of claim 10, wherein at least one of the data-processing operation, the second data-processing operation, and the third data-processing operation is corresponding to at least one of a ReLU (Rectified Linear Unit) Layer, a Sigmoid Layer, a Tanh Layer, a LeakyReLU Layer, a PReLU (Parametric ReLU) Layer, a Batch Normalization Layer, a Layer Normalization Layer, an Instance Normalization Layer, a Group Normalization Layer, an LSTM (Long Short-Term Memory) Layer, a GRU (Gated Recurrent Unit) Layer, a Simple RNN Layer, a Bidirectional RNN Layer, a Self-Attention Layer, a Multi-Head Attention Layer, a Cross-Attention Layer, a Dropout Layer for regularization, a Softmax Layer for classification outputs, an Embedding Layer for text or categorical data processing, an Upsampling/Deconvolution Layer, a Skip Connection/Residual Layer, an Addition/Concatenation Layer, an Average/Maximum Pooling Layer, a Reshape Layer, a Flatten Layer, a Transpose Layer, and a Padding Layer.
